(19) United States
(12) Patent Application Publication
(10) Pub. No.: US 2013/0169789 A1
(43) Pub. Date: Jul. 4, 2013

(54) OPTICAL INSPECTING SYSTEM

(71) Applicants: Ming-Han Lee, Taoyuan Hsien (TW); Che-Cheng Hu, Taoyuan Hsien (TW); Yi-Lung Weng, Taoyuan Hsien (TW)

(72) Inventors: Ming-Han Lee, Taoyuan Hsien (TW); Che-Cheng Hu, Taoyuan Hsien (TW); Yi-Lung Weng, Taoyuan Hsien (TW)

(21) Appl. No.: 13/663,092

(22) Filed: Oct. 29, 2012

(30) Foreign Application Priority Data
Dec. 29, 2011 (TW) 100149532

(51) Int. Cl. H04N 9/04

(52) U.S. Cl. 348/87; 348/E09.002

(57) ABSTRACT

An optical inspecting system for inspecting a surface of a solar cell chip includes a housing, a control device, an image capturing device and a lighting device configured in the housing. The lighting device provides monochromatic lights on the solar cell chip, and the image capturing device captures the image of the solar cell chip. The control device is electrically connected to the image capturing device and the lighting device for controlling the optical inspecting system to perform defect and color inspecting processes on the surface of the solar cell chip. By the communication among the image capturing device, the lighting device, and the control device, images with different resolutions can be obtained according to different inspecting processes, and monochrome sensor array can be used for decreasing error.

### PRIORITY CLAIM

This application claims the benefit of the filing date of Taiwan Patent Application No. 100149532, filed Dec. 29, 2011, entitled “OPTICAL INSPECTING SYSTEM,” and the contents of which is hereby incorporated by reference in their entirety.

### FIELD OF THE INVENTION

The present invention relates to an optical inspecting system, and more particularly to an optical inspecting system for inspecting a surface of a solar cell chip.

### BACKGROUND OF THE INVENTION

In recent years, due to the importance of environmental awareness, kinds of green energy sources have been developed such as: wind power, tidal power, geothermal heat, solar energy, and bioenergy; wherein the prospect of solar energy has become more noticeable and attractive.

In general, with photoelectric conversion, solar energy can be converted into electric energy through solar cell chips. To be noticed, the surface roughness of the solar cell chip is the key to enhance the energy conversion efficiency; however, in actual manufacturing process, there are many possibilities to generate defects on the surface of the solar cell chip (e.g., the process of crystal pulling, chamfering, slicing, etching, and cleaning), and theses defects may decrease the light absorption efficiency.

Additionally, the solar cell chip has an antireflection layer on surface, so as to reduce the reflectivity of the surface; in other words, the antireflection layer can improve the light absorption efficiency. The thickness of antireflective layer may affect the efficiency of the anti-reflective, and the thickness of antireflective layer can be differentiated by colors thereof, generally speaking, the color of the antireflective layer may become lighter with increasing the thickness of antireflective layer.

Therefore, the manufacturing process of solar cell chip can be improved by inspecting the color and the defect on the surface of the solar cell chip. In convention, the defect and color inspecting processes were relying on manual inspection methods; however, the determination by human eye observation may make a large error of accuracy, an inspecting system was proposed to solve this problem.

The conventional inspecting system adopts the colorful charge-coupled device and color filters to capture images; however, due to the quality of the color filters is difficult to control, the deviation of image quality may be increased. On the other hand, there is unnecessary to perform the color detection with the high resolution as performing the defect inspection. In order to complete the entire inspection in time, the defect and color inspecting processes of the solar cell chip are provided separately in the conventional methods, causing the increase of the equipment cost.

Accordingly, how to develop an optical inspecting system to improve the problems mentioned above is the primary topic in this field.

### SUMMARY OF THE INVENTION

Therefore, in order to improve the problem described previously, an aspect of the present invention is to provide an optical inspecting system for inspecting a surface of a solar cell chip.

According to an embodiment, the optical inspecting system is utilized for performing defect and color inspecting processes on the surface of the solar cell chip. The optical inspecting system comprises a housing, a control device, an image capturing device and a lighting device; wherein the image capturing device is configured in the housing and used for capturing the image of the solar cell chip according to a pulse signal. The lighting device is also configured in the housing for providing or stopping providing a light beam according to a triggering signal and an end signal respectively; and the control device is electrically connected to the image capturing device and the lighting device, and capable of controlling the optical inspecting system to perform the defect inspection and the color detection on the solar cell chip.

In the embodiment, when the defect inspection is performed, the lighting device can provide a first light beam and the image capturing device can capture the image of the solar cell chip with a first pixel combination; on the other hand, when the color detection is performed, the lighting device can provide a second light beam and the image capturing device can capture the image of the solar cell chip with a second pixel combination. Furthermore, the optical inspecting system of the embodiment is capable of capturing the images with different resolutions according to different inspecting processes with advantages of fast inspection speed and accurate, therefore, the invention can reduce the inspection cost of solar cell chips since just only one capturing images system is required.

Many other advantages and features of the present invention will be further understood by the detailed description and the accompanying sheet of drawings.

### BRIEF DESCRIPTION OF THE DRAWINGS

FIG. 1 is a schematic diagram illustrating an optical inspecting system according to an embodiment of the invention.

FIG. 2 is a flowchart illustrating the procedure of performing a defect inspection for a solar cell chip according to the optical inspecting system of FIG. 1.

FIG. 3 is a flowchart illustrating the procedure of performing a color detection for a solar cell chip according to the optical inspecting system of FIG. 1.

FIG. 4 is a flowchart illustrating the entire procedure of inspecting a solar cell chip according to the optical inspecting system of FIG. 1.

To facilitate understanding, identical reference numerals have been used, where possible to designate identical elements that are common to the figures.

### DETAILED DESCRIPTION

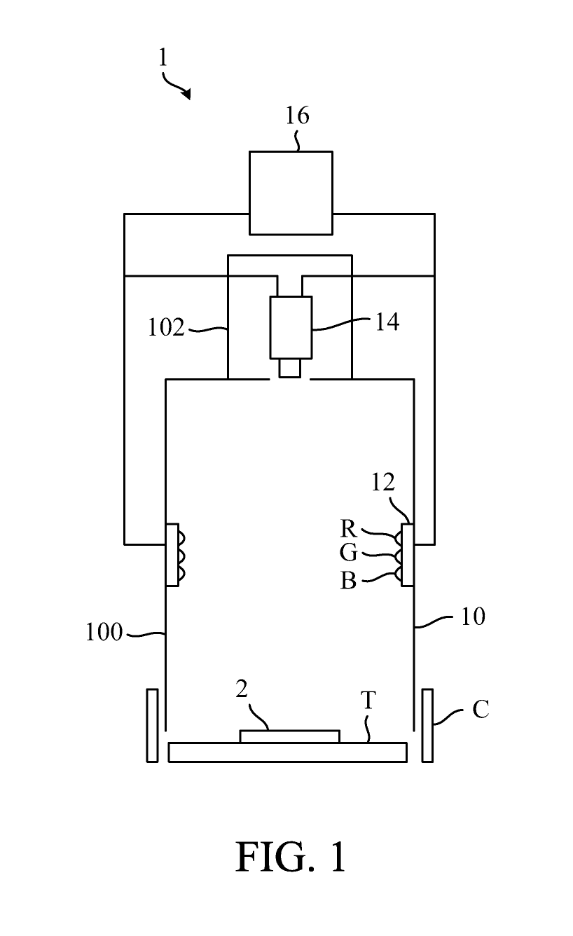

Please refer to FIG. 1. FIG. 1 is a schematic diagram illustrating an optical inspecting system according to an embodiment of the invention. As shown in FIG. 1, the optical inspecting system 1 comprises a housing 10, a lighting device 12, an image capturing device 14, and a control device 16; wherein the lighting device 12 and the image capturing device 14 are configured in the housing 10, and the control device 16 is electrically connected to the image capturing device 14 and the lighting device 12.

In the embodiment, the housing 10 further comprises a light box containing part 100 and an image capturing containing part 102; wherein the light box containing part 100 has an opening at the bottom thereof for disposing a conveyor belt T, so that the solar cell chip 2 can be conveyed into the light box containing part 100. The lighting device 12 is configured in the light box containing part 100 of the housing 10 for providing or stopping providing a light beam to the interior of the light box containing part 100 according to a triggering signal and an end signal respectively. The image capturing device 14 is configured in the image capturing containing part 102 of the housing 10 for capturing the image of the solar cell chip 2 according to a pulse signal. Moreover, the junction between the light box containing part 100 and the image capturing containing part 102 has an eyehole, thus through the eyehole, the image capturing device 14 can capture the image of the solar cell chip 2. In the embodiment, in order to prevent external ambient light from entering the housing 10 to affect the light beam emitted from the lighting device 12, the position of the light box containing part 100 may be settled as closer as possible to the conveyor belt T, and/or by adding the light-blocking components C at the both sides of the conveyor belt T.

More specifically, the lighting device 12 comprises various light-emitting elements for providing different light colors. In this embodiment, the lighting device 12 comprises a red light-emitting element R, a green light-emitting element G, and a blue light-emitting element B. The control device 16 is electrically connected to the image capturing device 14 and the lighting device 12, and used for controlling the optical inspecting system 1 to perform the defect inspection and the color detection on the solar cell chip 2; furthermore, the control device 16 is capable of controlling the pixel combination and the exposure time during capturing the image of the solar cell chip 2. To be noticed, the red light-emitting element R, the green light-emitting element G, and the blue light-emitting element B in FIG. 1 respectively represent a red LED, a green LED, and a blue LED, but it is not limited to this form, each light-emitting element can comprise a plurality of LEDs with corresponding colors thereof; that is to say, the number of the LEDs can be predetermined by user.

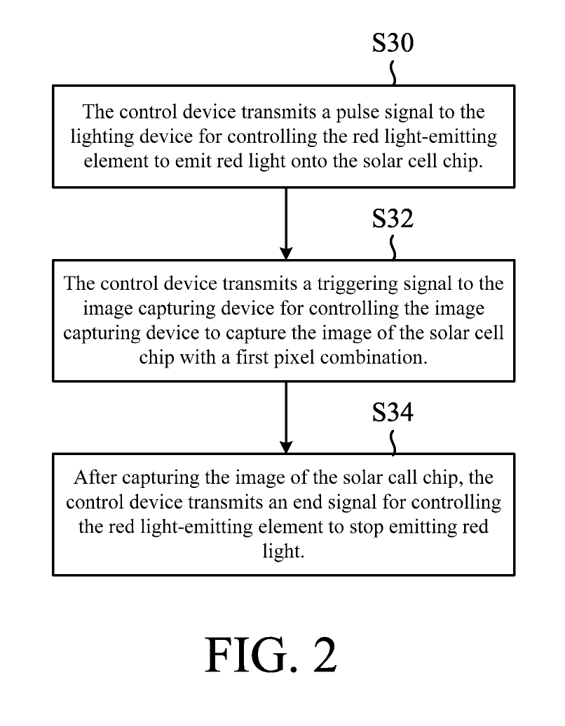

Please refer to FIG. 2. FIG. 2 is a flowchart illustrating the procedure of performing a defect inspection for a solar cell chip according to the optical inspecting system of FIG. 1. As shown in FIG. 2, at the step S30 of the defect inspection, the control device 16 transmits a pulse signal to the lighting device 12 for controlling the red light-emitting element R to emit a red light beam onto the solar cell chip 2; subsequently, at the step S32, the control device 16 transmits a triggering signal to the image capturing device 14 for controlling the image capturing device 14 to capture the image of the solar cell chip 2 with a first pixel combination; and afterward, at the step S34, the control device 16 transmits an end signal for controlling the red light-emitting element R to stop emitting the red light beam after capturing the image of the solar call chip 2. To be more precise, the image capturing device 14 works when the red light beam irradiates onto the solar call chip 2, therefore, the image capturing device 14 can adopt a monochrome sensing array in the procedure of defect inspection, such as monochrome charge-coupled device or complementary metal-oxide-semiconductor. In the embodiment, the defect inspection and the color detection can be performed under backlight conditions; accordingly, the optical inspecting system 1 can further comprise a backlight module (not shown in the figures) for providing background illumination during the inspecting processes continuously. In addition, the control device 16 can also control the luminescence mechanism of the green light-emitting element G and the blue light-emitting element B depending on user's demand.

Please refer to FIG. 1 again, the lighting device 12 is electrically connected with the image capturing device 14, therefore, the color detection can be performed through the data communication among the image capturing device 14, the lighting device 12, and the control device 16.

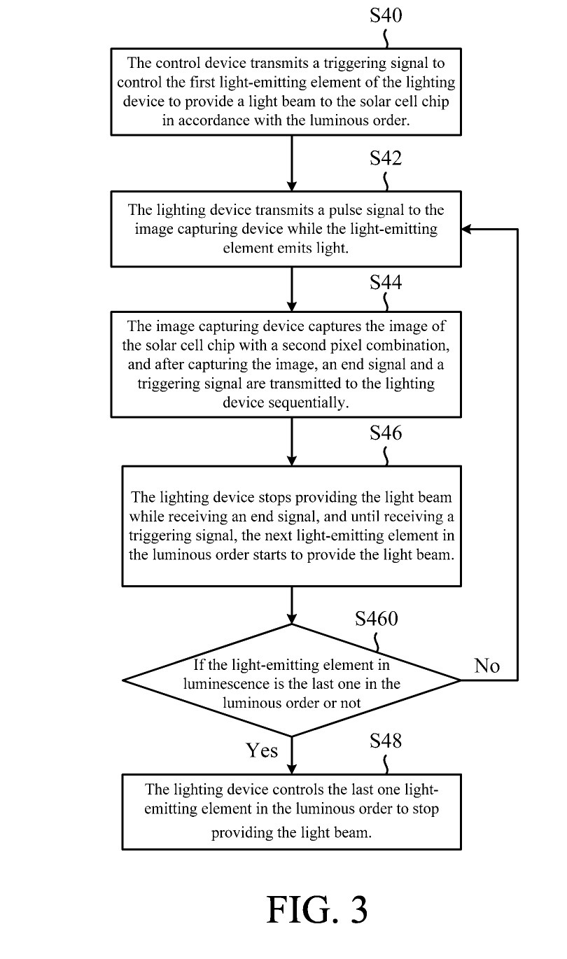

Please refer to FIG. 3. FIG. 3 is a flowchart illustrating the procedure of performing a color detection for a solar cell chip according to the optical inspecting system of FIG. 1. As shown in FIG. 3, at the step S40, the control device 16 transmits a triggering signal to control the first light-emitting element of the lighting device 12 to provide a light beam to the solar cell chip 2 in accordance with a luminous order; at the step S42, the lighting device 12 transmits a pulse signal to the image capturing device 14 while the light-emitting element emits light; at the step S44, the image capturing device 14 captures the image of the solar cell chip 2 with a second pixel combination, and after capturing the image, an end signal and a triggering signal are transmitted to the lighting device 12 sequentially; afterward, at the step S46, the lighting device 12 stops providing the light beam while receiving an end signal, and until receiving a triggering signal, the next light-emitting element in the luminous order starts to provide the light beam.

To be noticed, if the light-emitting element in luminescence at the step S46 is not the last one in the luminous order, the procedure of performing a color detection should be returned to the step S42 and further to repeat the steps S42 to S46; on the contrary, if the light-emitting element in luminescence at the step S46 is the last one in the luminous order, the procedure continues to the next step S48, as illustrated in the step S460. Finally, at the step S48, the lighting device 12 controls the last one light-emitting element in the luminous order to stop providing the light beam.

According to the steps described above, the control device 16 can transmit a triggering signal to the lighting device 12 for controlling the blue light-emitting element B to emit blue light; and meanwhile, the lighting device 12 transmits a pulse signal to the image capturing device 14 to proceed to a first image capturing action. After finishing the first image capturing action, the image capturing device 14 transmits an end signal to the lighting device 12 so as to control the blue light-emitting element B to stop providing the light beam; subsequently, a triggering signal may be transmitted from the image capturing device 14 to the lighting device 12 so as to drive the green light-emitting element G to emit green light. By the same token, the second image capturing action may be proceeded while the green light-emitting element G is lightening; and the third image capturing action may be proceeded while the red light-emitting element R is lightening. Finally, the lighting device 12 may turn the red light off to complete the procedure of the color detection, when the third image capturing action is finished.

Since the defect inspection and the color detection can be performed by capturing images in monochrome manner, the optical inspecting system 1 of the invention is capable of processing the two inspecting procedures in one time.

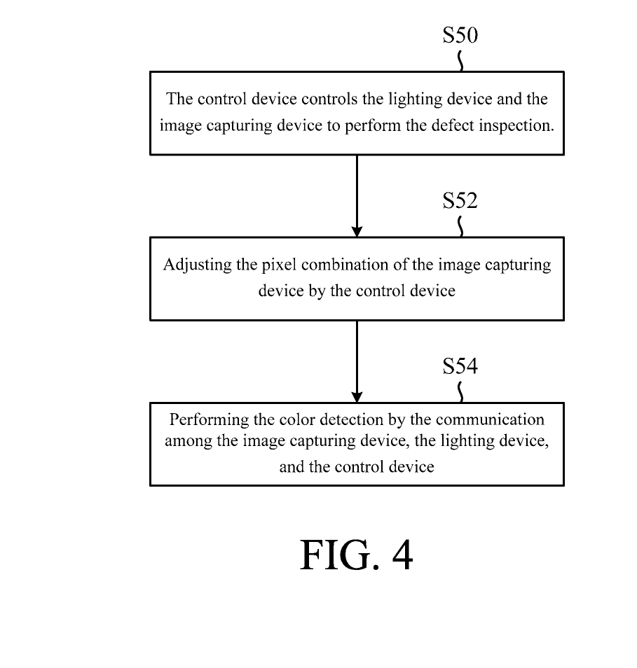

Please refer to FIG. 4. FIG. 4 is a flowchart illustrating the entire procedure of inspecting a solar cell chip according to the optical inspecting system of FIG. 1. As shown in FIG. 4, at the step S50, the control device 16 controls the lighting device 12 and the image capturing device 14 to perform the defect inspection; and then, the step S52 is to adjust the pixel combination of the image capturing device 14 by the control device 16; afterward, the step S54 is to perform the color detection by the communication among the image capturing device 14, the lighting device 12, and the control device 16. To be noticed, the steps S50 and S54 of performing the defect inspection and the color detection have been illustrated in detail as the descriptions of FIG. 2 and FIG. 3 respectively, thus the steps S50 and S54 need not to be elaborated further. After finishing the step S54, the solar cell chip 2 may be conveyed off the optical inspecting system 1 through the conveyor belt T, and further to inspect the next solar cell chip 2.

According to the embodiment, the optical inspecting system 1 of the invention captures the images with different resolutions by adjusting the pixel combination of the image capturing device 14 according to different inspecting processes. For example, the pixel combination of the image capturing device 14 can be adjusted to full resolution; in other words, the first pixel combination mentioned in the step S32 further comprises a plurality of original pixel data, and a 16M image is obtained during the step S50. Subsequently, the control device 16 may control the image device 14 to perform a 2×2 binning at the step S52; that is to say, the second pixel combination mentioned in the step S44 comprises a plurality of composite pixel data which are processed by binning, and each composite pixel data has a number of 2×2 original pixel data. Therefore, the image capturing device 14 may obtain three images with 4M in size at the step S54. In this manner, the image processing time can be decreased.

As shown in FIG. 4, the lighting device 12 can be divided as the first light-emitting module and the second light-emitting module for providing the monochromatic source of the defect inspection and the color detection respectively; in the embodiments mentioned above, the first light-emitting module comprises a red light-emitting element R and the second light-emitting module comprises a red light-emitting element R, a green light-emitting element G, and a blue light-emitting element B. In actual application, in order to prevent the light-emitting element from overheat, an appropriate luminous order is required; for example, when the first light-emitting module of the lighting device 12 is a red light-emitting element R, the luminous order of the light-emitting elements in the second light-emitting module is arranged from a blue light-emitting element B, a green light-emitting element G to a red light-emitting element R, therefore, the red light-emitting element R has an adequate cooling time during an entire procedure of inspecting a solar cell chip 2. Furthermore, according to another embodiment, the first light-emitting module and the second light-emitting module can severally adopt different red light-emitting elements R, thus the luminous order of the light-emitting elements need not be limited in this manner.

Besides, the entire inspection time of the solar cell chip 2 can also be reduced by using an appropriate application interface of the image capturing device 14. For example, Gig-E interface not only possesses quick transmission speed but also allows the pixel combination of the image capturing device 14 to be adjusted expediently and swiftly (less than 20 ms); therefore, Gig-E interface is a more suitable candidate for serving as the application interface of the image capturing device 14.

Please refer to FIG. 1 again. In the embodiment, each light-emitting element can be a LED source, and the luminous surface thereof can be oriented toward the internal surface of the light box containing part 100. The internal surface of the light box containing part 100 has been treated with white frosted surface treatment, so as to reflect the light emitted from the light-emitting elements and further to improve the precision of image. In order to avoid the light beam emitted from the lighting device 12 entering the image capturing containing part 102 and being scattered, the internal surface of the image capturing containing part 102 has been treated with black matte surface treatment.

According to the embodiment mentioned above, the procedure of the color detection is performed in RGB, thus the mapped color should be transformed to CIE Lab color space. More specifically, this transformation process can be performed by a processing unit or the control device 16; for example, the control device 16 can be a computer to deal with the images.

Accordingly, the optical inspecting system of the embodiment is capable of capturing the images with different resolutions according to different inspecting processes with advantages of fast inspection speed and accurate, therefore, the invention can reduce the inspection cost of solar cell chips since just only one capturing images system is required.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. An optical inspecting system, for performing a defect inspection and a color detection for a solar cell chip, comprising:
a housing, for disposing the solar cell chip;
an image capturing device, configured in the housing, for capturing the image of the solar cell chip according to a pulse signal;
a lighting device, configured in the housing, for providing a light beam according to a triggering signal and stopping providing the light beam according to an end signal; and
a control device, electrically connected to the image capturing device and the lighting device, for controlling the optical inspecting system to perform the defect inspection and the color detection on the solar cell chip;
wherein when the defect inspection is performed, the lighting device provides a first light beam and the image capturing device captures the image of the solar cell chip with a first pixel combination; and when the color detection is performed, the lighting device provides a second light beam and the image capturing device captures the image of the solar cell chip with a second pixel combination.

2. The optical inspecting system of claim 1, wherein the image capturing device is a monochrome sensor array.

3. The optical inspecting system of claim 2, wherein the monochrome sensor array comprises one of a monochrome charge-coupled device and a complementary metal-oxide-semiconductor.

4. The optical inspecting system of claim 1, wherein the lighting device comprises a red light-emitting element, a green light-emitting element, and a blue light-emitting element.

5. The optical inspecting system of claim 4, wherein the first light beam is provided from the red light-emitting element; and the second light beam is provided from one of the red light-emitting element, the green light-emitting element, and the blue light-emitting element.

6. The optical inspecting system of claim 1, wherein the image capturing device receives the pulse signal from the control device; and the lighting device receives the triggering signal and the end signal from the control device.

7. The optical inspecting system of claim of claim 1, wherein when the color detection is performed, the lighting device receives the triggering signal and the end signal from the image capturing device, and the image capturing device receives the pulse signal from the lighting device.

8. The optical inspecting system of claim 1, wherein the housing comprises an image capturing containing part and a light box containing part; the image capturing device is configured within the image capturing containing part and the lighting device is configured within the light box containing part; the internal surfaces of the image capturing containing part and the light box containing part have been treated with black matte and white frosted surface treatments respectively.

9. The optical inspecting system of claim 8, wherein the lighting device provides light beam onto the internal surface of the light box containing part, and the light beam is scattered to the solar cell chip by the internal surface of the light box containing part.

10. The optical inspecting system of claim 1, wherein the first pixel combination further comprises a plurality of original pixel data, and the second pixel combination comprises a plurality of composite pixel data processed by binning.
